(19) United States
(12) Patent Application Publication
(10) Pub. No.: US 2004/0257919 A1
(43) Pub. Date: Dec. 23, 2004

(54) Integrated device for reading

(75) Inventor: Hsiang-An Hsieh, Hsin-Dien City (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng. Co., Ltd.

(21) Appl. No.: 10/612,165

(22) Filed: Jul. 3, 2003

(30) Foreign Application Priority Data
Jun. 18, 2003 (TW) 092211122

(51) Int. Cl. H04B 1/20

(52) U.S. Cl. 369/1

(57) ABSTRACT

The present invention relates to an integrated device for reading, which can integrate card reader with disk driver without changing the size of frame of prior disk driver, and can be installed where the prior disk driver is originally installed so that the card reader becomes a standard device for the computer. Therefore, practicability, functionality and value can be increased.

### FIELD OF THE INVENTION

The present invention relates to an integrated device for reading, particularly to an integrated device which integrates disk driver with card reader so that it can be installed in the frame of the computer.

### BACKGROUND OF THE INVENTION

Memory cards are used in digital camera (DSC), digital video camera, personal digital assistant (PDA) and digital recording device etc to store data and image. Widely-used memory cards are divided into: Compact Flash card (CF), MircoDriver card (MD), MultiMedia card (MMC), Smart card (SM), Secured Digital card (SD), Memory Stick card (MS) etc. If a user wants to store the data in a memory card in a computer so that he can do subsequent image processing, storing, playing or printing, the following ways are usually used:

1. A signal wire is used to connect the digital devices to the computer, then the computer stores the data through driver program in the digital devices. The storing speed in this way is too slow, especially the digital camera. A high-capacity memory card (such as 512M, 1 G or a larger one) is needed to reach a high pixel and to store a large amount of photos. The speed is very slow if data of Such a high capacity is read and stored through a wire.

2. Card readers are used to read data. Now card readers are all additionally configured. They are connected to the mainframe in an independent or inbuilt way. And the user can operate the memory cards as memory devices of the computer to read and store the data. Card readers are popular because of high reading speed and convenience. However, card readers that are connected to computer both in inbuilt or external way have the following disadvantages: occupying a large space and complex dismounting. Therefore they are inconvenient in use.

Also, some manufactures now install a card reader in the printer. Therefore the printer can read the data in the memory card to print directly without connecting to the computer, however, the data read by the printer can not be transmitted to the computer to store or make further processing so that pleasure of image processing is decreased.

### OBJECT OF THE INVENTION

It's an object of the present invention to provide an integrated device for reading, which can integrate card reader with disk driver without changing the size of frame of prior disk driver, and can be installed where the prior disk driver is originally installed so that the card reader becomes a standard device for the computer. Therefore, practicability, functionality and value can be increased.

Said disk driver is a thin floppy disk driver. The floppy disk driver and the card reader are overlapped in the integrated device, which has standard floppy disk frame. The integrated device comprises two rows of slots on the front panel, one row corresponds to the disk socket in the floppy disk driver, the other row is used to receive memory cards.

It's another object of the present invention to use original frame of floppy disk driver and the original position in the computer. And it is unnecessary for the computer to add a new socket to install card reader so that cost can be reduced, and it doesn't occupy extra space, and mainframe of the computer will have a higher expanding ability.

### BRIEF DESCRIPTION OF THE DRAWINGS

FIG. 1 is a three-dimensional diagram of an integrated device according to the present invention;

FIG. 2 is a three-dimensional exploded diagram of an integrated device according to the present invention;

FIG. 3 is circuit diagrams of receiving part and memory card controller of the card reader;

FIG. 4 is an outside three-dimensional view of the integrated device installing in the computer;

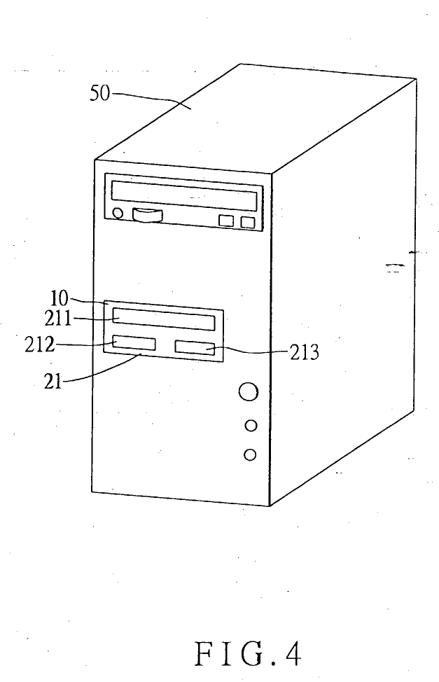

FIG. 5 is the diagram of the first embodiment.

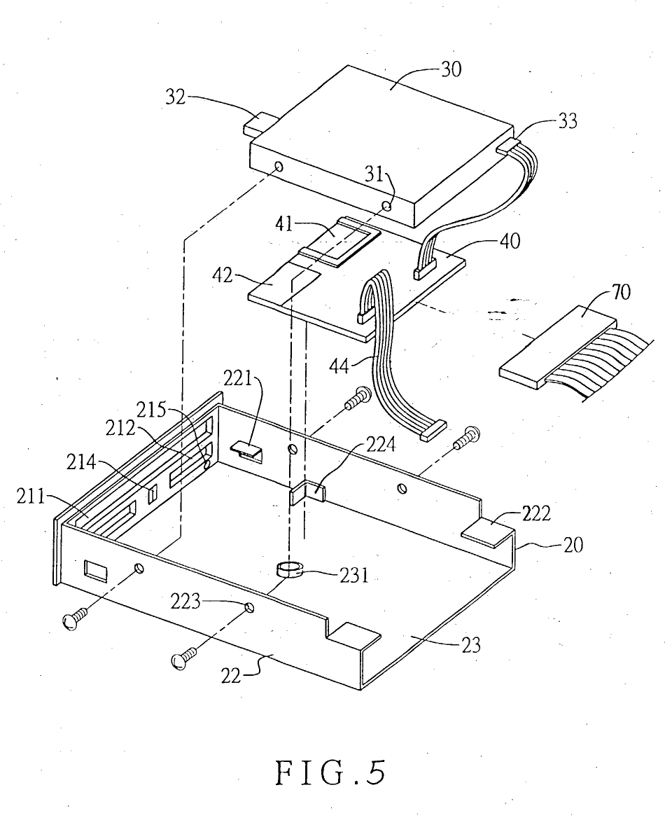

10 integrated device

20 frame

21 front panel

211 slot

212 slot

213 slot

214 secure part

215 hole

216 depression

22 side panel

221 front dependent panel

222 back dependent panel

223 the same bolt hole as bolt hole 31

224 dependent panel

23 backboard

231 protrude

30 the floppy disk device

31 bolt hole

32 release key

33 transmission element

40 card reader

41 socket

42 socket

43 memory card controller

44 connection wire

50 mainframe

60 bus circuit board

70 bus

### DETAILED DESCRIPTION OF THE EMBODIMENTS

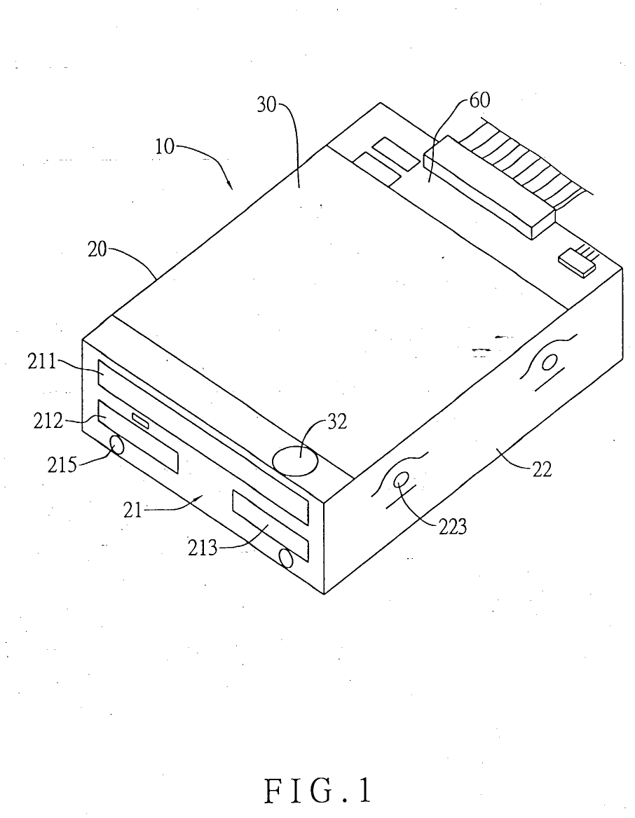

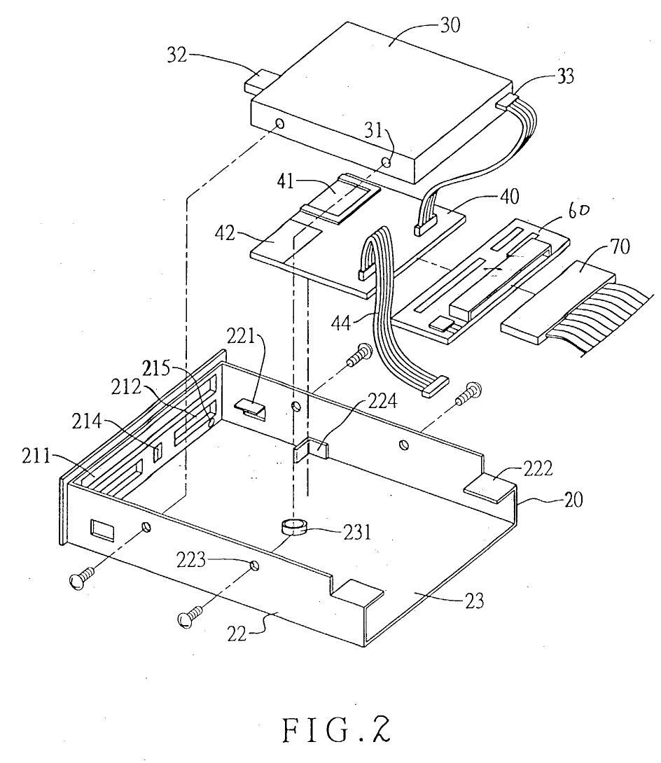

FIG. 1 shows a three-dimensional diagram of an integrated device according to the present invention; FIG. 2 shows a three-dimensional exploded diagram according to an integrated device of the present invention; wherein the frame 20 of the integrated device 10 comprises:

Front panel 21, comprises two rows of slots; slot 211 corresponds to the disk socket in the floppy disk driver 30. There are at least one slot in the other row, e.g. 2 slots 212, 213 in the this embodiment, and slots 212, 213 are respectively used to receive CF/PCMCIA, SM, MS, SD, MMC, xD cards to insert; the front panel 21 is installed inside of the frame 20 with a secure part 214 on it.

Holes 215 are provided under the slots, which are used to receive display lamps of floppy disk driver 30 and card reader 40. The lamps are used to display the working states of the floppy disk driver 30 and card reader 40. And a depression 216 is provided at the top of the front panel 21.

Side panels 22, which are provided in symmetry. Front dependent panels 221 and back dependent panels 222 are provided at two ends of the same side of the side panels 22. The same bolt holes 223 as bolt holes 31 in the floppy disk driver 30 are provided corresponding to bolt holes 31. Straight dependent boards 224 are provided at the bottom of the side panels 22.

Backboards 23, thereon a protrude 231 with bolt hole is provided to correspond to the card reader 40 to fix the card reader 40. Therefore sockets 41, 42 on the card reader 40 can correspond to slots 212, 213.

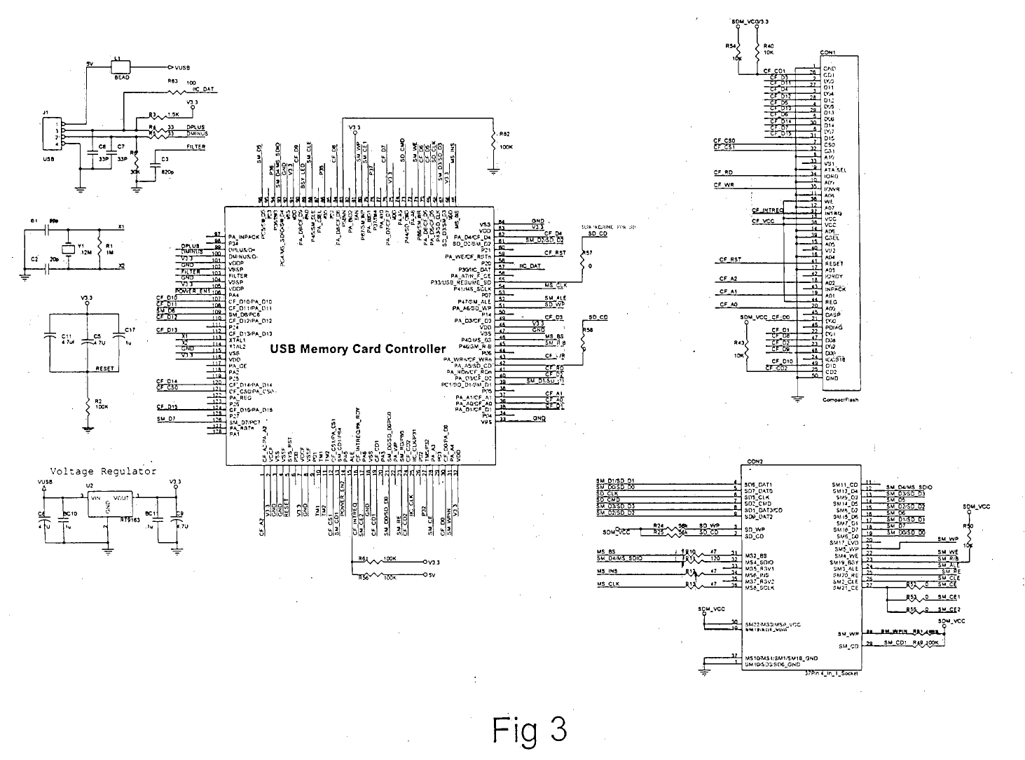

The card reader 40 is a bare board which has 2 sockets 41, 42, which is used to receive memory cards such as CF/PCMCIA, SM, MS, SD, MMC and xD etc. FIG. 3 shows a circuit diagrams of receiving part and memory card controller of the card reader. The top right corner of FIG. 3 shows socket 41 to receive CF, Mirco driver/PCMCIA cards, and the below right corner of FIG. 3 shows socket 42 to receive SM, MS, SD, MMC, xD. The two sockets 41 and 42 are connected to the memory card controller 43. The memory card controller 43 reads signals from sockets 41 and 42 and integrated them to an USB signal (or IDE, IEEE1394 or PCI signals). Then the signals are transmitted to the computer through a connection wire 44.

An end of the sockets 41, 42 of the card reader 40 is inserted in the secure part 214, the other end is arranged on said dependent boards, and the underside is arranged on the protrude 231 so that the card reader 40 is secured in the frame 20. At the same time the two sockets 41, 42 of the card reader 40 can correspond to slots 212, 213 of the front panel 21.

The floppy disk driver 30 is overlapped above the card reader 40. Two ends of the floppy disk driver 30 are on the front and back dependent panels 221, 222. The release key 32 of the floppy disk driver 30 is arranged in the depression 216 of the front panel 21. Then the same bolt hole 223 as bolt hole 31 and the bolt hole 31 are secured by a secure element 42. Thus the floppy disk driver 30 and the frame 20 are secured. At the same time the slot to receive floppy in the floppy disk driver 30 can correspond to the slot 211.

In addition, a bus circuit board 60 is provided on the back dependent panel 222 (FIG. 2). And a bus 70 connects the floppy disk driver 30 to the mainframe 50 to provide power supply for the floppy disk driver 30. The bus circuit board 60 can be omitted if USB floppy disk driver is used.

In addition, a transmission element 33 can be provided at the back end of the floppy disk driver 30. And a bus 70 connects the floppy disk driver 30 to the card reader 40, and to the mainframe 50 through the card reader 40 to provide power supply for the floppy disk

1. An integrated device for reading, comprising a frame, a floppy disk driver and a card reader that overlap in the frame, wherein the front panel comprises two rows of slots, one row corresponds to the disk socket in the floppy disk driver, the other row is used to receive memory cards, the integrated device makes the card reader and the floppy disk driver install in a computer.

2. An integrated device for reading according to claim 1, wherein a secure part is provided at side of the front panel.

3. An integrated device for reading according to claim 1, wherein the card reader has two sockets to receive memory cards.

4. An integrated device for reading according to claim 3, wherein one socket is used to receive CF, Mirco driver/PCMCIA cards, the other one is used to receive SM, MS, SD, MMC, xD cards.

5. An integrated device for reading according to claim 1, wherein the disk driver is a thin floppy disk driver.

6. An integrated device for reading according to claim 1, wherein a depression is provided at the top of the front panel to receive the release key.

7. An integrated device for reading according to claim 1, wherein the frame further comprises two side panels, inwardly fold front dependent panels and back dependent panels are provided at two ends of the same side of the side panels, straight dependent boards are provided at the bottom of the side panels.

8. An integrated device for reading according to claim 1, wherein an end of the card reader is inserted in said secure part, the other end is arranged on said dependent boards and secured with the protrude by secure elements, therefore the card reader is secured in the frame.

9. An integrated device for reading according to claim 1, wherein the disk driver is arranged on the front dependent panels and back dependent panels and secured by a secure element.

10. An integrated device for reading according to claim 7, wherein a bus circuit board is provided on the back dependent panel, and the floppy disk driver is connected to the mainframe by the bus to provide power supply for the floppy disk driver 30

11. An integrated device for reading according to claim 1, wherein a transmission element is provided at the back end of the floppy disk driver, and a bus connects the floppy disk driver to the card reader, and to the mainframe through the card reader to provide power supply for the floppy disk driver.
